(19) United States
(12) Patent Application Publication
(10) Pub. No.: US 2026/0039372 A1
(43) Pub. Date: Feb. 5, 2026

(54) METHOD AND SYSTEM FOR LOW EARTH ORBIT SATELLITE MULTI-CONNECTION AND COMMUNICATION USING GRATING LOBES

(71) Applicant: KOREA UNIVERSITY RESEARCH AND BUSINESS FOUNDATION, Seoul (KR)

(72) Inventors: Wonjae SHIN, Seoul (KR); Juha PARK, Suwon-si (KR)

(21) Appl. No.: 19/284,496

(22) Filed: Jul. 29, 2025

(30) Foreign Application Priority Data
Jul. 30, 2024 (KR) 10-2024-0100668
May 16, 2025 (KR) 10-2025-0064071

(51) Int. Cl. H04B 7/185

(52) U.S. Cl. CPC H04B 7/18513; H04B 7/18519

(57) ABSTRACT

A method and system for low Earth orbit (LEO) satellite multiple access and communication using grating lobes is disclosed. The method may include: acquiring ephemeris data for a plurality of LEO satellites; predicting an orbital trajectory for each of the plurality of LEO satellites based on the ephemeris data; selecting target satellites using the predicted orbital trajectories; adjusting an antenna array to form grating lobes in the directions of the selected target satellites; and transmitting and receiving data with the target satellites using the adjusted antenna array.

### CROSS-REFERENCE TO RELATED APPLICATION

This application claims the benefit of priority under 35 U.S.C. § 119(a) to Korean Patent Application Nos. 10-2024-0100668 filed on Jul. 30, 2024, and 10-2025-0064071 filed on May 16, 2025, the entire contents of which are incorporated herein by reference.

### BACKGROUND

### (a) Technical Field

The present disclosure relates to a method and system for multi-connection and communication in low Earth orbit (LEO) satellites using grating lobes.

### (b) Background Art

In next-generation communication systems beyond 5G, ultra-connectivity, ultra-high speed, and ultra-low latency must be achieved, which requires both wider bandwidth and wide-area coverage simultaneously.

However, meeting these requirements through terrestrial networks alone inevitably necessitates the use of high-frequency bands such as millimeter wave (mmWave) and terahertz (THz). These bands suffer from severe propagation loss, which significantly reduces the coverage area of a single base station. As a result, an extremely large number of base stations must be deployed, leading to a sharp increase in installation and maintenance costs of communication infrastructure, thereby posing significant economic challenges.

As a potential solution, the deployment of satellite networks in space—such as low Earth orbit (LEO), medium Earth orbit (MEO), and geostationary orbit (GEO)—is receiving increasing attention. Among them, LEO satellites offer the key advantage of low latency due to their lower altitude, and they are capable of delivering high-quality services over wide areas with a relatively small number of satellites.

In next-generation communication systems beyond 5G, low Earth orbit (LEO) satellite communication is regarded as a key technology for providing global coverage with high throughput. In LEO satellite communication, analog beamforming with high gain, based on array antennas, is critical to compensate for severe signal attenuation.

Also, achieving high throughput necessitates a technological shift from conventional narrowband transmission to wideband-based transmission. While research utilizing mm Wave and THz bands is actively underway in terrestrial wideband communication, narrowband communication still remains the mainstream in the field of low Earth orbit (LEO) satellite communication.

In conventional phased array antennas, the typical approach has been to design the antenna spacing to be smaller than half-wavelength to prevent grating lobes, which are unwanted additional beams formed in directions other than the main lobe. However, there is potential to improve the performance and stability of LEO satellite communication systems by utilizing grating lobes rather than suppressing them, enabling capabilities such as multiple satellite connectivity, soft handover, and high data rate multicasting.

Additionally, in wideband systems with wide bandwidth, the frequency-flat response of conventional phase shifters causes beam-squint phenomenon, where the beam slightly deviates from the intended direction depending on frequency. This beam-squint effects must be mitigated to improve the stability and system performance of LEO satellite communication systems.

### SUMMARY OF THE DISCLOSURE

The present disclosure relates to a method and system for multiple access and communication with low Earth orbit (LEO) satellites using grating lobes.

Further, the present disclosure provides a method and system for multiple access and communication with LEO satellites using grating lobes, which enables simultaneous connections with a plurality of LEO satellites and efficient multicast/broadcast transmission by optimizing the geometric structure of the antenna array and adaptively utilizing grating lobes.

In addition, the present disclosure provides a method and system for multiple access and communication with LEO satellites using grating lobes, which supports soft handover by utilizing both main lobes and grating lobes, thereby enabling seamless handover and offering more stable and reliable satellite communication services.

Furthermore, the present disclosure provides a method and system for multiple access and communication with LEO satellites using grating lobes, which can compensate for beam squint phenomena in broadband environments, thereby efficiently utilizing all frequency resources.

According to one aspect of the present invention, a method for multiple access and communication with low Earth orbit (LEO) satellites using grating lobes is provided.

According to one embodiment of the present invention, the method may include: acquiring ephemeris data for a plurality of LEO satellites; predicting orbital trajectories of the respective LEO satellites based on the acquired ephemeris data; selecting target satellites using the predicted orbital trajectories; adjusting an antenna array such that grating lobes are formed in the respective directions of the selected target satellites; and transmitting and receiving data with the selected target satellites using the adjusted antenna array.

Adjusting the antenna array may include adjusting the spacing between antenna elements using a movable antenna array such that grating lobes are formed in the respective directions of the selected target satellites.

Adjusting the antenna array may include configuring a sub-antenna array by selectively activating a portion of the antenna elements so that grating lobes are formed in the respective directions of the selected target satellites.

Adjusting the antenna array may include both adjusting the spacing between antenna elements using a movable antenna array and selectively activating some of the antenna elements to configure a sub-antenna array so that grating lobes are formed in the respective directions of the selected target satellites.

Transmitting and receiving data with the target satellites may include controlling at least one of a true time delay (TTD) element and a phase shifter using precomputed Doppler shifts based on the location of a ground station, so as to form beams in different directions for respective frequencies or to compensate for beam squint, thereby enabling data communication with the target satellites.

In addition, transmitting and receiving data with the target satellites may include maintaining a connection with a currently communicating target satellite using a main lobe, and performing a pre-connection with a handover target satellite using a grating lobe, thereby supporting soft handover.

According to another embodiment of the present invention, a method for multiple access and communication with low Earth orbit (LEO) satellites using grating lobes is provided. The method may include: acquiring location information of each of a plurality of ground terminals; selecting multicast target terminals based on the respective location information of the ground terminals; adjusting an antenna array such that a main lobe and at least one grating lobe are formed in the respective directions of the selected multicast target terminals; and transmitting data to the selected multicast target terminals in a multicast manner using the adjusted antenna array.

According to another aspect of the present invention, a system for performing the method of multiple access and communication with LEO satellites using grating lobes is provided.

According to one embodiment of the present invention, the system may include: an antenna array unit comprising a plurality of antenna elements; a data acquisition unit configured to acquire ephemeris data for a plurality of LEO satellites; an orbit prediction unit configured to predict the orbital trajectory of each of the plurality of LEO satellites based on the acquired ephemeris data; a selection unit configured to select target satellites using the predicted orbital trajectories; an antenna array adjustment unit configured to adjust the spacing between the plurality of antenna elements such that grating lobes are formed in the respective directions of the selected target satellites, and to selectively activate a subset of the antenna elements to configure a sub-antenna array; and a transceiver configured to perform beamforming using the sub-antenna array and to transmit and receive data with the target satellites.

The transceiver may be configured to adjust at least one of a true time delay (TTD) element and a phase shifter based on precomputed Doppler shifts using the location information of a ground station, so as to form beams in different directions for respective frequencies or to compensate for beam squint, thereby enabling data communication with the target satellites.

According to another embodiment of the present invention, the system may include: an antenna array unit comprising a plurality of antenna elements; a data acquisition unit configured to acquire location information of each of a plurality of ground terminals; a selection unit configured to select multicast target terminals based on the respective location information of the ground terminals; an antenna array adjustment unit configured to adjust the spacing between the antenna elements such that a main lobe and at least one grating lobe are formed in the respective directions of the selected multicast target terminals, and to selectively activate a subset of the antenna elements to configure a sub-antenna array; and a transceiver configured to perform beamforming for each multicast group using the sub-antenna array and to transmit data to the selected multicast target terminals in a multicast manner.

In addition, by applying a non-uniform movable antenna array, the present disclosure enables flexible adjustment of beamforming and resource allocation in response to various communication requirements such as traffic load and latency. This provides the advantage of achieving advanced communication optimization, which is difficult to accomplish with conventional uniform array-based systems.

### BRIEF DESCRIPTION OF DRAWINGS

FIG. 1 is a diagram schematically illustrating a system configuration according to an embodiment of the present disclosure.

FIG. 2 is a block diagram schematically illustrating the internal configuration of a ground station according to an embodiment of the present disclosure.

FIG. 3 is a block diagram schematically illustrating the internal configuration of a low Earth orbit satellite according to an embodiment of the present disclosure.

FIG. 4 is a flowchart illustrating a method for multi-connection and communication using grating lobes in a low Earth orbit satellite according to an embodiment of the present disclosure.

FIG. 5 is a diagram illustrating a process of multi-connection with multiple low Earth orbit satellites at different time points using a mobile antenna array according to an embodiment of the present disclosure.

FIG. 6 is a diagram illustrating a method of selectively activating some of the antenna elements according to an embodiment of the present disclosure.

FIG. 7 is a diagram illustrating a soft handover using grating lobes according to an embodiment of the present disclosure.

FIG. 8 is a flowchart illustrating a process of simultaneously connecting to a plurality of ground terminals using grating lobes in a low Earth orbit satellite according to an embodiment of the present disclosure.

FIG. 9 is a diagram illustrating multicast transmission in a satellite downlink using grating lobes according to an embodiment of the present disclosure.

### DETAILED DESCRIPTION

Singular forms used in this specification include plural forms unless the context clearly indicates otherwise. In the specification, the term “configured”, “include”, or the like should not be construed as necessarily including several components or several steps described herein, in which some of the components or steps may not be included or additional components or steps may be further included. Further, the terms “˜ unit”, “module”, and the like mean a unit for processing at least one function or operation and may be implemented by hardware or software or by a combination of hardware and software.

Hereinafter, the embodiments of the present disclosure will be described in detail with reference to the accompanying drawings.

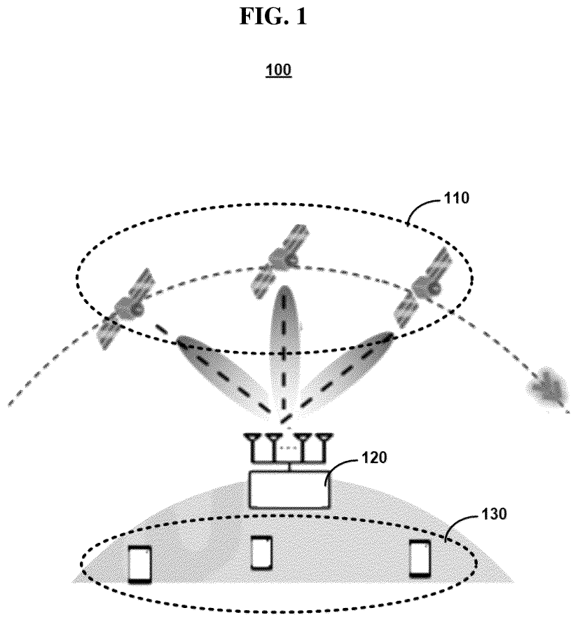

FIG. 1 is a diagram schematically illustrating a system configuration according to an embodiment of the present disclosure.

Referring to FIG. 1, a system 100 according to an embodiment of the present disclosure includes a plurality of low Earth orbit (LEO) satellites 110, a plurality of ground terminals 130, and a ground station 120.

The plurality of LEO satellites 110 are multiple satellites orbiting along low Earth orbit (LEO), each of which performs communication with the plurality of ground terminals 130 and the ground station 120.

The LEO satellites 110 are equipped with an antenna array capable of performing multi-beamforming that includes a main lobe and one or more grating lobes. Through this configuration, each LEO satellite 110 can simultaneously communicate with multiple ground terminals 130, other LEO satellites, and the ground station 120. As will be described in more detail below, the LEO satellites 110 can perform communication in a multi-connection and multicast manner by utilizing the grating lobes.

The plurality of ground terminals 130 may include various types of devices such as mobile communication terminals, IoT terminals, vehicle-mounted terminals, and fixed receiving stations. The ground terminals 130 may receive data from the LEO satellites 110 via multicast or unicast transmission, or may transmit data to the LEO satellites 110.

The ground station 120 is a terrestrial communication base station that communicates with the plurality of LEO satellites 110 and is responsible for orbit control of the LEO satellites 110, communication schedule management, and overall system operation. Also, the ground station 130 includes an antenna array capable of performing multi-beamforming using grating lobes for communication with a plurality of LEO satellites 110, and may simultaneously connect to the plurality of LEO satellites 110 by utilizing a main lobe and one or more grating lobes.

In the communication system 100 according to an embodiment of the present disclosure, the LEO satellites 110 and the ground station 120 may each perform multi-beamforming using grating lobes, enabling simultaneous communication with multiple ground terminals 130 and multiple LEO satellites 110. The system may be configured to enable high-efficiency communication through orbital movement prediction and frequency-dependent beamforming control. This will be described in greater detail below.

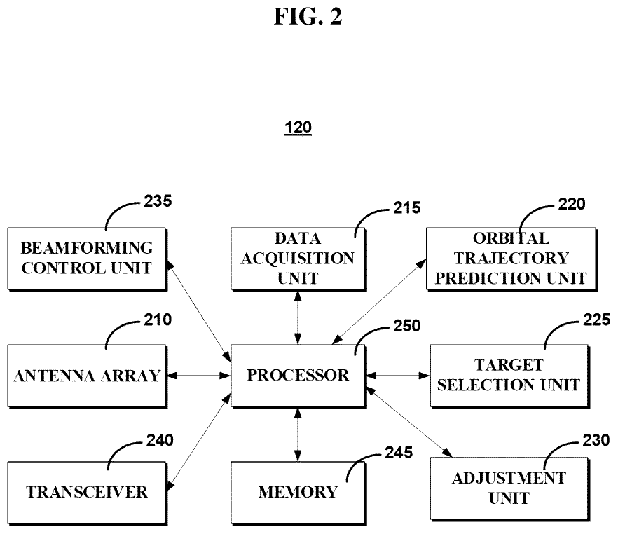

FIG. 2 is a block diagram schematically illustrating the internal configuration of a ground station according to an embodiment of the present disclosure.

Referring to FIG. 2, a ground station 120 according to an embodiment of the present disclosure includes an antenna array 210, a data acquisition unit 215, an orbital trajectory prediction unit 220, a target selection unit 225, an adjustment unit 230, a beamforming control unit 235, a transceiver 240, a memory 245, and a processor 250.

The antenna array 210 includes a plurality of antenna elements, and the plurality of antenna elements may form a movable antenna array or a non-uniform antenna array.

The movable antenna array is configured such that each antenna element is movable, and the spacing between the antenna elements can be dynamically adjusted according to the communication environment or the location of a target terminal or satellite. In this case, the antenna elements may be supported by movement rails, sliding tracks, or motorized actuators, and each antenna element link may be independently moved and adjusted in response to control signals. Through this configuration, the spacing between the antenna elements can be varied to form a main lobe and one or more grating lobes in specific directions.

In the non-uniform antenna array, a plurality of antenna elements are arranged at regular intervals, but are selectively activated, and the spacing between the antenna elements may be adjustable. This will be described in more detail below.

Although not explicitly shown in FIG. 2, true time delay (TTD) elements and phase shifters (PS) may be included below the antenna array 210.

The true time delay (TTD) element compensates for phase differences that vary with frequency, thereby correcting beam squint and maintaining the beam direction in wideband signals.

In addition, the phase shifter (PS) provides frequency-independent phase adjustments to each antenna element, enabling basic beamforming.

Furthermore, although not explicitly shown in FIG. 2, the system may further include an RF chain and a baseband processing unit.

The RF chain serves as an independent path for processing radio frequency signals for each antenna element, and may include components such as a low noise amplifier (LNA), a mixer, a frequency synthesizer, an analog-to-digital converter (ADC), and a digital-to-analog converter (DAC).

The RF chain may amplify transmitted and received signals, perform frequency conversion and modulation/demodulation, and enable signal processing in conjunction with the baseband processing unit.

The baseband processing unit processes signals converted by the RF chain in a digital manner, and may perform functions such as digital modulation and demodulation, error correction, encoding and decoding, beamforming weight calculation, link control, and scheduling.

In addition, the baseband processing unit may support the function of optimizing communication quality in both transmission and reception paths and dynamically controlling the beamforming direction based on orbital trajectory prediction information.

The data acquisition unit 215 is a means for acquiring ephemeris data for the plurality of low Earth orbit (LEO) satellites 110. The ephemeris data may include information such as satellite position, velocity, orbital elements, reference time, and error estimation. The communication system 100 may calculate the current and future orbital positions of each satellite based on the ephemeris data. The communication system 100 may acquire the ephemeris data either through direct transmission from each LEO satellite system or via a ground control station.

The orbital trajectory prediction unit 220 is a means for predicting the orbital trajectories of low Earth orbit (LEO) satellites based on the acquired ephemeris data.

For example, the orbital trajectory prediction unit 220 may predict the orbital paths of the satellites by applying Kepler's orbital equations using the current position and velocity based on the orbital elements of each LEO satellite. A detailed description thereof will be omitted since it is well known to those skilled in the art.

The target selection unit 225 selects connectable target satellites and/or soft handover target satellites based on the predicted orbital trajectory information. The target selection unit 225 may also manage the current and predicted positions of the selected satellites.

The adjustment unit 230 may adjust the spacing between elements of antenna arrays composed of a plurality of antenna elements, or selectively activate a subset of the antenna elements to configure a sub-antenna array.

That is, the adjustment unit 230 may configure a sub-antenna array by adjusting the spacing between antenna elements or selectively activating a subset of the antenna elements, such that a main lobe and at least one grating lobe are formed in the direction of each connectable target satellite or soft handover target satellite.

The main lobe may be formed by configuring the spacing between antenna elements to be less than or equal to λ/2, and by adjusting the phase weights of each element to perform beamforming in a desired main direction. In this case, the phase difference for beamforming can be represented as Δϕ=−kd sin (θ). where k=2 π/λ denotes the wave number, d denotes the spacing between adjacent antenna elements, and 0 represents the beamforming angle.

When the spacing between antenna elements exceeds ½, multiple directions with the same phase difference may exist, leading to the formation of grating lobes. The condition under which grating lobes occur is given by d sin (θ)=nλ(n=0, ±1, ±2, . . . ). Here, n=0 corresponds to the main lobe, and all other values of n represent grating lobes. Therefore, if a solution exists for n≠0, a grating lobe is formed in the corresponding angular direction. Accordingly, the angle at which a grating lobe occurs can be calculated as

$${θ}_{G L} = {sin}^{- 1} ( \frac{n λ}{d} ) .$$

The adjustment unit 230 may configure a sub-antenna array by adjusting the spacing between antenna elements or by selectively activating a subset of the antenna elements such that a main lobe and at least one grating lobe are formed in the direction of each connectable target satellite or soft handover target satellite.

The beamforming control unit 235 performs control of beamforming to effectively form a main lobe and grating lobes in the respective directions of a plurality of target satellites or a plurality of ground terminals, based on the sub-antenna array of the antenna array.

The beamforming control unit 235 may set and control a time delay value for each antenna element in order to compensate for beam squint that may occur during wideband signal transmission. Through this, the beam can be consistently maintained in the target direction regardless of frequency.

In addition, the beamforming control unit 235 may perform basic beamforming by adjusting the phase of transmission or reception signals to match the phase differences between elements. In non-wideband or low-frequency environments, beamforming may be sufficiently achieved using only phase shifters.

The beamforming control unit 235 may adjust phase and time delay so as to simultaneously form multiple beams, including not only a single main lobe but also one or more grating lobes. Through this, multiple access to a plurality of target satellites can be supported, and soft handover can be enabled.

The transceiver 240 is responsible for transmitting and receiving data with a plurality of target satellites based on signals provided from the antenna array unit 210 and the beamforming control unit 235.

More specifically, the transceiver 240 can perform simultaneous data transmission and reception with a plurality of communication targets (i.e., target satellites) using the main lobe and at least one grating lobe. In this case, the transceiver 240 may maintain a primary communication link through the main lobe while forming or maintaining additional communication links in advance through the grating lobe(s).

Additionally, the transceiver 240 may support soft handover when communicating with moving low Earth orbit (LEO) satellites by maintaining the existing connection while preparing a new connection with another LEO satellite. That is, the transceiver 240 can utilize the main lobe and the grating lobe(s) to ensure seamless communication during the handover process without any interruption.

Additionally, the transceiver 240 may dynamically switch between transmission and reception paths, or activate and deactivate dedicated beams for specific communication targets in response to commands from the beamforming control unit.

In addition, the transceiver 240 may perform modulation and encoding on transmission data, and demodulation and decoding on reception data, and may also perform error detection and error correction functions as needed.

The memory 245 stores various instructions for performing the method for multi-connection and communication with LEO satellites using grating lobes, according to an embodiment of the present disclosure.

The processor 250 is a means for controlling the internal components of the ground station 120 according to an embodiment of the present disclosure, including, for example, the antenna array 210, the data acquisition unit 215, the orbital prediction unit 220, the target selection unit 225, the adjustment unit 230, the beamforming control unit 235, the transceiver 240, and the memory 245.

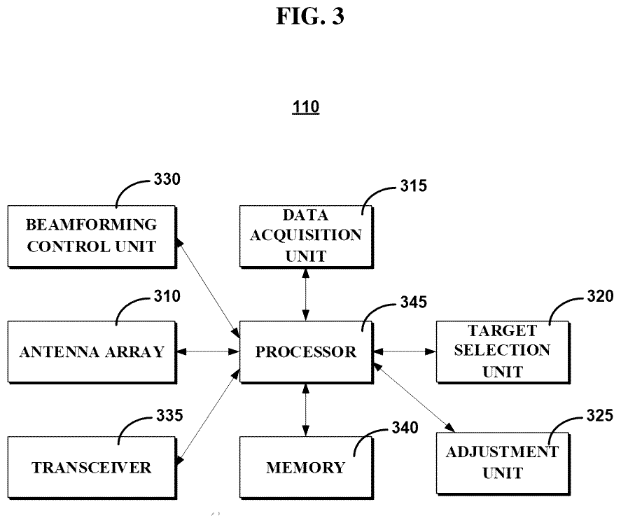

FIG. 3 is a block diagram schematically illustrating the internal configuration of a low Earth orbit satellite according to an embodiment of the present disclosure.

Referring to FIG. 3, a LEO satellite 110 according to an embodiment of the present disclosure includes an antenna array 310, a data acquisition unit 315, a target selection unit 320, an adjustment unit 325, a beamforming control unit 330, a transceiver 335, a memory 340, and a processor 345.

The antenna array 310 includes a plurality of antenna elements, which may form a movable antenna array or a non-uniform antenna array. Since this configuration is the same as that described with respect to the antenna array 210 of FIG. 2, a redundant description will be omitted.

The data acquisition unit 315 performs a function of acquiring location information of each of the plurality of ground terminals. The location information of the ground terminals may be received from a ground station, or acquired through self-observation or an inter-satellite link (ISL). The data acquisition unit 315 may also acquire astronomical data of other LEO satellites.

For convenience of explanation and understanding, it is assumed that the LEO satellite performs multiple access and/or multicast communication with a ground station or ground terminals, and the description is centered around this case. However, the LEO satellite may also perform multiple access with other LEO satellites using grating lobes. This can be performed in the same manner as described in FIG. 2.

The target selection unit 320 may select ground terminals to be multicast targets based on the acquired location information. The selection criteria may include location, communication quality, service requirements, and the like.

The adjustment unit 325 may adjust the spacing between the plurality of antenna elements or selectively activate a subset of the antenna elements to form a sub-antenna array, such that a main lobe and at least one grating lobe are formed in the respective directions of the selected multicast target terminals.

Since this is the same as described with respect to FIG. 2, a redundant description will be omitted.

The beamforming control unit 330 is configured to control beamforming based on the sub-array of the antenna array unit, so as to form a main lobe and at least one grating lobe in the direction of each selected multicast target terminal.

In addition, the beamforming control unit 330 may control a time delay (TTD) element to compensate for phase differences that vary with frequency, in order to correct beam squint effects that may occur in a wideband communication environment.

The beamforming control unit 330 may also perform phase adjustment of transmission and reception signals to support the simultaneous formation of a single main lobe and multiple grating lobes.

The transceiver 335 transmits data to the selected plurality of ground terminals in a multicast manner based on signals received from the antenna array 310 and the beamforming control unit 330, and may also receive data as needed.

The transceiver 335 maintains communication with a primary terminal through the main lobe and simultaneously communicates with additional terminals through grating lobes, thereby supporting high-efficiency multi-user access.

In addition, the transceiver 335 may perform modulation and encoding on transmission data, demodulation and decoding on reception data, and may also perform error detection and error correction as needed.

The memory 340 stores various instructions and control data for performing a multi-user access and multicast transmission method using grating lobes according to an embodiment of the present disclosure.

The processor 345 performs control of the internal components of the LEO satellite 110, including, for example, the antenna array 310, the data acquisition unit 315, the target selection unit 320, the adjustment unit 325, the beamforming control unit 330, the transceiver 335, and the memory 340.

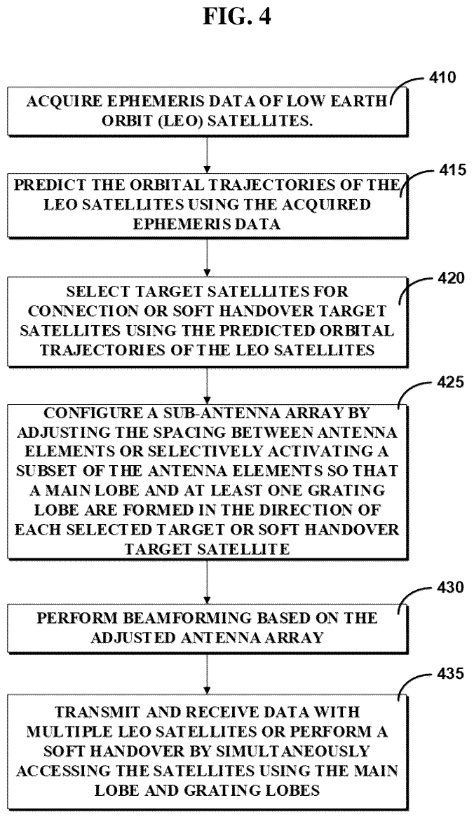

FIG. 4 is a flowchart illustrating a method for multi-connection and communication with LEO satellites using grating lobes, according to an embodiment of the present disclosure.

In step 410, the ground station 120 acquires ephemeris data of LEO satellites. The acquired data may include satellite position, velocity, orbital elements, reference time, and error information.

In step 415, the ground station 120 predicts the orbital trajectories of the LEO satellites using the acquired astronomical data. Through this process, the communication system 100 can calculate the available communication time and relative positions of the LEO satellites.

In step 420, the ground station 120 selects a target satellite for connection or a soft handover target satellite using the predicted orbital trajectories of the LEO satellites.

In step 425, the ground station 120 adjusts the spacing between antenna elements or selectively activates a subset of the antenna elements to form a sub-antenna array, such that a main lobe and at least one grating lobe are formed in the respective directions of the selected target satellite or soft handover target satellite.

In step 430, the ground station 120 performs beamforming based on the adjusted antenna array. In this case, the ground station 120 may use time delay (TTD) elements and phase shifters for each antenna element to perform frequency-optimized beamforming or to compensate for beam squint phenomena.

In step 435, the ground station 120 may perform data transmission and reception or soft handover by establishing multiple connections with a plurality of LEO satellites using the main lobe and grating lobes. That is, the ground station 120 transmits and receives data with a currently connected target satellite through the main lobe, and establishes a preliminary connection with a soft handover target satellite through a grating lobe, thereby enabling multiple access and soft handover with multiple LEO satellites.

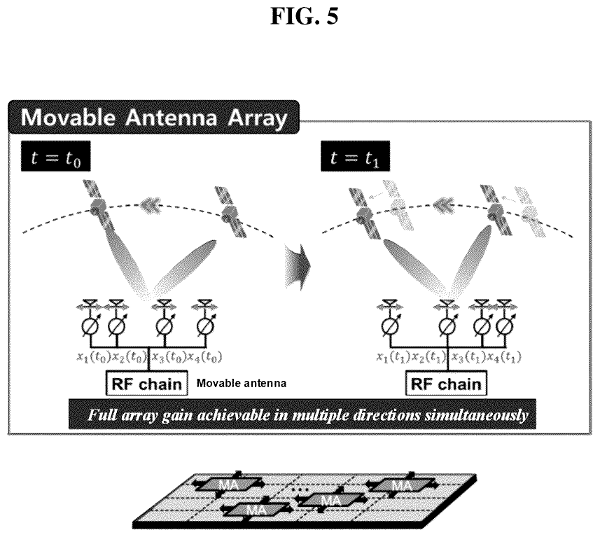

FIG. 5 is a diagram illustrating a process of establishing multi-connection with multiple LEO satellites at different time points using a movable antenna array.

At a first time point (t₀), it is assumed that LEO satellites A and B are present, and at a second time point (t₁), the positions of LEO satellites A and B have changed.

At the first time point, the ground station 120 may adjust the spacing between antenna elements or selectively activate a subset of the antenna elements in the directions corresponding to the positions of LEO satellites A and B, thereby forming a main lobe and at least one grating lobe to perform simultaneous beamforming in multiple directions, enabling concurrent connection to multiple satellites.

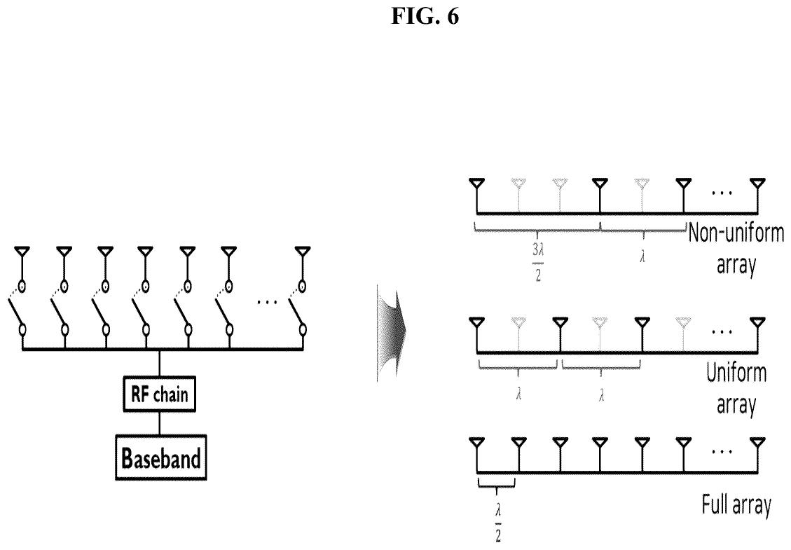

Under this condition, if the positions of LEO satellites A and B change along different orbital paths at the second time point, the ground station 120 may re-adjust the spacing between antenna elements or selectively activate a subset of the antenna elements (see FIG. 6) in the respective updated directions, thereby forming a new main lobe and at least one grating lobe to support continued multi-satellite connection.

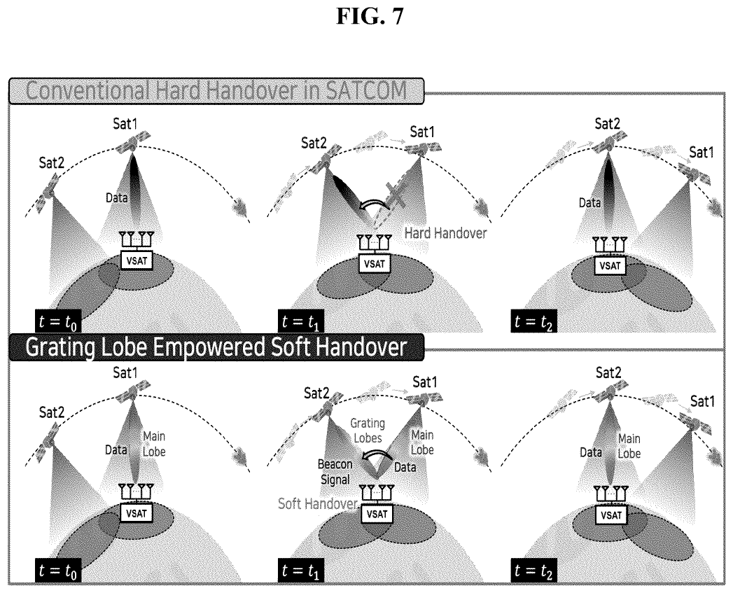

FIG. 7 is a diagram illustrating an example of soft handover using grating lobes. As shown in FIG. 7, the system may be configured to control beam squint while efficiently utilizing all frequency resources and enabling simultaneous connection to multiple LEO satellites by utilizing grating lobes.

In particular, by forming communication links in multiple directions in addition to the main lobe using grating lobes, it becomes possible to realize soft handover-which was not feasible in conventional systems that support only single-beam steering (e.g., ground stations based on phased array antennas with a single RF chain).

More specifically, due to the high mobility of satellites in a LEO system, handovers occur very frequently. In conventional systems, only hard handovers are supported, which may result in temporary data transmission interruptions or communication loss during handover.

However, in an embodiment of the present disclosure, the ground station 120 can maintain communication with a currently connected target satellite through the main lobe while simultaneously establishing a pre-connection with a handover target satellite using a grating lobe. Accordingly, soft handover can be achieved, allowing communication quality to be maintained even during the handover period.

For example, consider a scenario in which communication is being conducted with a first satellite at a first point in time, and a handover to a second satellite occurs at a second point in time. In this case, the ground station 120 can support soft handover by maintaining continuous communication with the first satellite via the main lobe while simultaneously establishing a preliminary link with the second satellite via a grating lobe at the second point in time. This enables the system to flexibly cope with frequent handovers that may occur LEO satellite networks, thereby providing more stable and seamless satellite communication services.

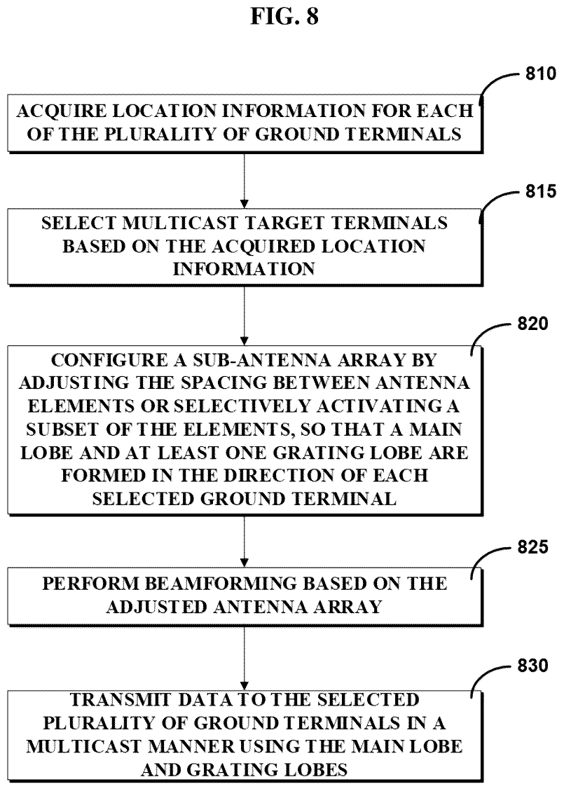

FIG. 8 is a flowchart illustrating a process in which a LEO satellite simultaneously connects to a plurality of ground terminals using grating lobes, according to an embodiment of the present disclosure.

In step 810, the LEO satellite acquires location information for each of the plurality of ground terminals. The location information may be received from a ground station or collected via inter-satellite links (ISLs) or onboard sensors.

In step 815, the LEO satellite 110 selects multicast target terminals based on the acquired location information. For example, the selection may be based on terminal location, communication quality, service requirements, and the like.

In step 820, the LEO satellite 110 adjusts the spacing between a plurality of antenna elements or selectively activates a subset of the antenna elements to form a sub-array, such that a main lobe and at least one grating lobe are formed in the direction of each of the selected ground terminals.

In step 825, the LEO satellite 110 performs beamforming based on the adjusted antenna array. In this step, the LEO satellite 110 may adjust the beam direction optimized for each frequency using a true time delay (TTD) element and a phase shifter (PS), or compensate for beam squint that may occur in wideband communication.

In step 830, the LEO satellite 110 transmits data in a multicast manner to the selected plurality of ground terminals through the main lobe and the grating lobes. Depending on the implementation, the LEO satellite may also communicate with certain terminals in a unicast manner in parallel.

The communication system according to an embodiment of the present disclosure can support frequency-efficient multicast and broadcast traffic transmission based on wide coverage, which is one of the key roles expected of satellite communication in a 6G network environment.

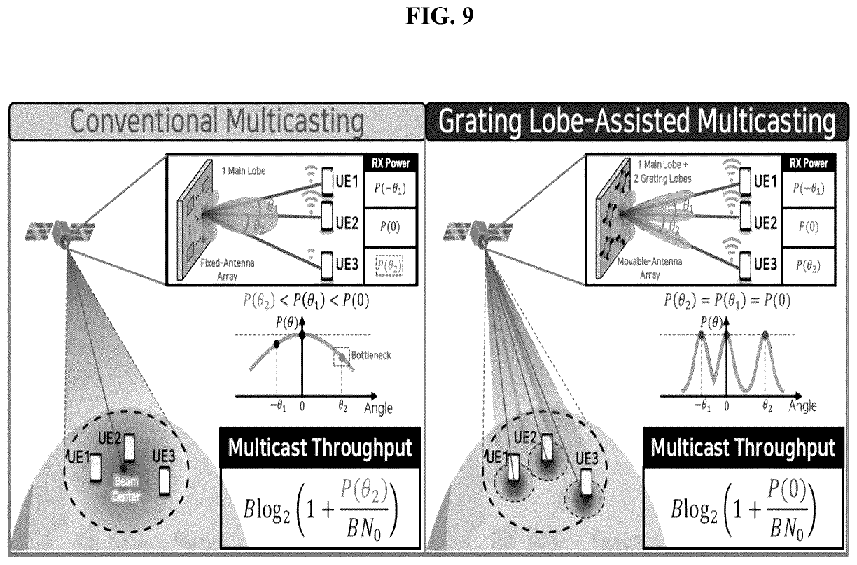

As illustrated in FIG. 9, multicast transmission using grating lobes in a satellite downlink can overcome conventional technical limitations and enhance overall system throughput.

More specifically, as shown on the left side of FIG. 9, conventional multicast communication typically employs a fixed antenna array structure and transmits data to multiple ground terminals using only a single main lobe. As a result, in the prior art, the overall multicast throughput may be determined by the terminal with the poorest signal quality among all user terminals-typically the one located at the edge of the beam. Consequently, degradation in the reception quality of terminals positioned far from the beam center leads to a bottleneck that limits the overall multicast throughput, ultimately causing deterioration in communication performance.

However, the communication system 100 according to an embodiment of the present invention can address such bottlenecks by optimizing the geometric structure of the antenna array to form grating lobes in desired directions. In particular, by concentrating grating lobes in regions where terminals with weak signal reception are located, the overall system performance can be improved and reception quality can be equalized across users.

In addition, the communication system (100) may apply a non-uniform movable antenna array to perform frequency-dependent beamforming, taking into account the geometric structure of the antenna array and the characteristics of grating lobes. This enables the achievement of low interference, high gain, and high frequency resource utilization efficiency. Accordingly, the communication system according to an embodiment of the present disclosure can provide flexible and adaptive high-performance satellite multicast and broadcast services.

The device and method according to the embodiments of the present disclosure may be implemented in a program that can be executed by various computers and may be recorded on computer-readable media. The computer-readable media may include program commands, data files, and data structures individually or in combinations thereof. The program commands that are recorded on a computer-readable media may be those specifically designed and configured for the present disclosure or may be those known to those engaged in the computer software field and thus available. The computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory. The program commands include not only machine language codes compiled by a compiler, but also high-level language code that can be executed by a computer using an interpreter, etc.

The hardware device may be configured to operate as one or more software modules to perform the operation of the present disclosure, and vice versa.

The present disclosure was described above focusing on the embodiments thereof. It would be understood by those skilled in the art that the present disclosure may be implemented in a modified form without departing from the scope of the present disclosure. Therefore, the disclosed embodiments should be considered in terms of explaining, not limiting. The scope of the present disclosure is shown in the claims, not in the above description, and all differences within an equivalent range should be construed as being included in the present disclosure.

What is claimed is:

1. A method for multiple access and communication with low Earth orbit (LEO) satellites using grating lobes, the method comprising:
acquiring ephemeris data for a plurality of LEO satellites;
predicting orbital trajectories of the respective LEO satellites based on the ephemeris data;
selecting target satellites using the predicted orbital trajectories;
adjusting an antenna array such that grating lobes are formed in the respective directions of the selected target satellites; and
transmitting and receiving data with the selected target satellites using the adjusted antenna array.

2. The method of claim 1,
wherein the step of adjusting the antenna array comprises:
adjusting the spacing between antenna elements using a movable antenna array such that grating lobes are formed in the respective directions of the selected target satellites.

3. The method of claim 1,
wherein the step of adjusting the antenna array comprises:
forming a sub-antenna array by selectively activating a subset of antenna elements such that grating lobes are formed in the respective directions of the selected target satellites.

4. The method of claim 1,
wherein the step of adjusting the antenna array comprises:
adjusting the spacing between antenna elements using a movable antenna array and forming a sub-antenna array by selectively activating a subset of the antenna elements such that grating lobes are formed in the respective directions of the selected target satellites.

5. The method of claim 1,
wherein the step of transmitting and receiving data with the target satellites comprises:
adjusting at least one of a true time delay (TTD) element and a phase shifter based on pre-calculated Doppler shifts derived from the location information of a ground station, thereby forming beams in different directions for each frequency or controlling beam squint, to transmit and receive data with the target satellites.

6. The method of claim 1,
wherein the step of transmitting and receiving data with the target satellites comprises:
maintaining a connection with a currently communicating target satellite using a main lobe, and performing a pre-connection with a handover target satellite using a grating lobe, thereby performing a soft handover.

7. A method for multiple access and communication with low Earth orbit (LEO) satellites using grating lobes, the method comprising:
acquiring location information for each of a plurality of ground terminals;
selecting multicast target terminals based on the respective location information of the plurality of ground terminals;
adjusting an antenna array such that a main lobe and at least one grating lobe are formed in the direction of each of the selected multicast target terminals; and
transmitting data in a multicast manner using the adjusted antenna array.

8. A low Earth orbit (LEO) satellite communication system comprising:
an antenna array unit comprising a plurality of antenna elements;
a data acquisition unit configured to acquire ephemeris data for a plurality of LEO satellites;
an orbit prediction unit configured to predict orbital trajectories of the respective LEO satellites based on the ephemeris data;
a selection unit configured to select target satellites using the predicted orbital trajectories;
an antenna array adjustment unit configured to adjust spacings between the plurality of antenna elements and selectively activate a subset of the antenna elements to form a sub-antenna array such that grating lobes are formed in the respective directions of the selected target satellites; and
a transceiver configured to transmit and receive data with the target satellites by performing beamforming using the sub-antenna array.

9. The low Earth orbit (LEO) satellite communication system of claim 8,
wherein the transceiver is configured to transmit and receive data with the target satellites by adjusting at least one of a true time delay (TTD) element and a phase shifter using pre-calculated Doppler shifts based on position information of a ground station,
thereby forming beams in different directions for respective frequencies or compensating for beam squint.

10. A low Earth orbit (LEO) satellite communication system comprising:
an antenna array unit comprising a plurality of antenna elements;
a data acquisition unit configured to acquire location information of each of a plurality of ground terminals;
a selection unit configured to select multicast target terminals based on the respective location information of the plurality of ground terminals;
an antenna array adjustment unit configured to adjust the spacing between the plurality of antenna elements and selectively activate a subset of the antenna elements to form a sub-antenna array such that a main lobe and at least one grating lobe are formed in the direction of each of the selected multicast target terminals; and
a transceiver configured to perform beamforming for each multicast group using the sub-antenna array and to transmit data to the multicast target terminals in a multicast manner.
